(19) United States
(12) Patent Application Publication
(10) Pub. No.: US 2025/0213984 A1
(43) Pub. Date: Jul. 3, 2025

(54) PROGRAM, INFORMATION PROCESSING SYSTEM, AND INFORMATION PROCESSING METHOD

(71) Applicant: CYGAMES, INC., Tokyo (JP)

(72) Inventors: Iyo Matsushita, Tokyo (JP); Mitsuharu Isojima, Tokyo (JP); Tomohiro Hasegawa, Tokyo (JP); Yuka Tanaka, Tokyo (JP); Hiroshi Yoshioka, Tokyo (JP); Shintaro Tamura, Tokyo (JP); Masashi Kachi, Tokyo (JP)

(73) Assignee: CYGAMES, INC., Tokyo (JP)

(21) Appl. No.: 19/083,912

(22) Filed: Mar. 19, 2025

Related U.S. Application Data
(63) Continuation of application No. PCT/JP2023/034063, filed on Sep. 20, 2023.

(30) Foreign Application Priority Data
Sep. 27, 2022 (JP) 2022-153353

(51) Int. Cl. A63F 13/69; A63F 13/53; A63F 13/65

(52) U.S. Cl. CPC A63F 13/69; A63F 13/53; A63F 13/65

(57) ABSTRACT

Provided are a program, an information processing system, and an information processing method that can proactively motivate players to play games by using various game media. A walk parameter is accumulated in accordance with a usage status of a game, and selection of an event-targeted character is received when the walk parameter satisfies a condition for executing an event and the event is executable. On the condition that the walk parameter is consumed, the event is executed in association with the event-targeted character, and an affinity parameter associated with the event-targeted character is updated based on a result obtained from executing the event.

### CROSS-REFERENCE TO RELATED APPLICATIONS

This application is a continuation of International Patent Application No. PCT/JP2023/034063, having an international filing date of Sep. 20, 2023, which designated the United States, the entirety of which is incorporated herein by reference. Japanese Patent Application No. 2022-153353 filed on Sep. 27, 2022 is also incorporated herein by reference in its entirety.

### BACKGROUND OF THE INVENTION

The present invention relates to programs, information processing systems, and information processing methods for games.

In a known game in the related art, a player selects a game medium, such as a character, a parameter indicating the degree of usage of the game medium based on execution of the game using the selected game medium changes, and content associated with the game medium can be released based on the parameter indicating the degree of usage of the game medium (see Japanese Unexamined Patent Application, Publication No. 2022-93716).

The player tends to select the game medium to be used in the game by focusing on the performance and the features of the game medium. This causes bias to occur in the usage frequency between game media and may lead to stagnation in the granting of bonuses, such as releasing of content for a less-frequently-used game medium, as well as a reduced level of interest in the parameter indicating the degree of usage and lower usage frequency. This is problematic in that it is difficult for the mechanism for strengthening the emotional attachment to the game medium and the entire game to function properly.

### SUMMARY OF THE INVENTION

The present invention has been made in view of the circumstances mentioned above, and an object thereof is to provide a program, an information processing system, and an information processing method that can proactively motivate players to play games by using various game media.

According to a first aspect of the disclosure, there is provided a program causing a computer to function as:
a first parameter updater that updates a first parameter accumulated in accordance with a usage status of a game;
an execution condition determiner that determines whether or not the first parameter satisfies a condition for executing an event;
a selection receiver that receives selection of an event-targeted game medium when the event is executable;
an event executer that executes the event in association with the event-targeted game medium on a condition that the first parameter is consumed; and
a second parameter updater that updates a second parameter associated with the event-targeted game medium based on a result obtained from executing the event.

According to a second aspect of the disclosure, there is provided an information processing system comprising:
a first parameter updater that updates a first parameter accumulated in accordance with a usage status of a game;
an execution condition determiner that determines whether or not the first parameter satisfies a condition for executing an event;
a selection receiver that receives selection of an event-targeted game medium when the event is executable;
an event executer that executes the event in association with the event-targeted game medium on a condition that the first parameter is consumed; and
a second parameter updater that updates a second parameter associated with the event-targeted game medium based on a result obtained from executing the event.

According to a third aspect of the disclosure, there is provided an information processing method comprising:
a first parameter updating step for updating a first parameter accumulated in accordance with a usage status of a game;
an execution condition determining step for determining whether or not the first parameter satisfies a condition for executing an event;
a selection receiving step for receiving selection of an event-targeted game medium when the event is executable;
an event executing step for executing the event in association with the event-targeted game medium on a condition that the first parameter is consumed; and
a second parameter updating step for updating a second parameter associated with the event-targeted game medium based on a result obtained from executing the event.

### BRIEF DESCRIPTION OF DRAWINGS

FIG. 1 illustrates the overall configuration of an information processing system.

FIG. 2 is a functional block diagram of a server related to a raising feature, a competition feature, and a walk event feature among features implemented in the information processing system.

FIG. 3 is a functional block diagram of a player terminal related to the raising feature, the competition feature, and the walk event feature among the features implemented in the information processing system.

FIG. 4 is a flowchart illustrating an example of a walk-event-related process.

FIG. 5 illustrates an example of a log-in display screen displayed on the player terminal.

FIG. 6 illustrates an example of a home screen displayed on the player terminal.

FIG. 7 illustrates an example of a character selection dialog displayed on the player terminal.

FIG. 8 illustrates an example of a feature guide dialog displayed on the player terminal.

FIG. 9 illustrates an example of the character selection dialog displayed on the player terminal.

FIG. 10 illustrates an example of the character selection dialog displayed on the player terminal.

FIG. 11 illustrates an example of the character selection dialog displayed on the player terminal.

FIG. 12 illustrates an example of a destination selection dialog displayed on the player terminal.

FIG. 13 illustrates an example of a reward selection dialog displayed on the player terminal.

FIG. 14 illustrates an example of an execution confirmation dialog displayed on the player terminal.

FIG. 15 illustrates an example of an animation effect displayed on the player terminal.

FIG. 16 illustrates an example of a walk result dialog displayed on the player terminal.

FIG. 17 illustrates an example of a trainer note displayed on the player terminal.

FIG. 18 illustrates an example of an effect dialog displayed on the player terminal.

### DETAILED DESCRIPTION OF THE INVENTION

(1) The present embodiment relates to a program for causing a computer to function as: a first parameter updater that updates a first parameter accumulated in accordance with a usage status of a game; an execution condition determiner that determines whether or not the first parameter satisfies a condition for executing an event; a selection receiver that receives selection of an event-targeted game medium when the event is executable; an event executer that executes the event in association with the event-targeted game medium on a condition that the first parameter is consumed; and a second parameter updater that updates a second parameter associated with the event-targeted game medium based on a result obtained from executing the event.

(2) The program according to the present embodiment may further cause the computer to function as a content releaser that releases content associated with the event-targeted game medium based on the result obtained from executing the event.

(3) In the program according to the present embodiment, the first parameter updater may update the first parameter in association with a log-in to the game.

(4) In the program according to the present embodiment, the first parameter updater may allow the first parameter to be resettable at a periodically-occurring reset timing.

(5) In the program according to the present embodiment, a plurality of types of events may be executable for each game medium, the selection receiver may receive selection of an event as an execution target after the event-targeted game medium is selected, and the event executer may execute the event selected as the execution target.

(6) In the program according to the present embodiment, the selection receiver may allow an event completion status of each game medium to be visually recognizable on an input interface that receives the selection related to the event-targeted game medium.

(7) The present embodiment relates to an information processing system including: a first parameter updater that updates a first parameter accumulated in accordance with a usage status of a game; an execution condition determiner that determines whether or not the first parameter satisfies a condition for executing an event; a selection receiver that receives selection of an event-targeted game medium when the event is executable; an event executer that executes the event in association with the event-targeted game medium on a condition that the first parameter is consumed; and a second parameter updater that updates a second parameter associated with the event-targeted game medium based on a result obtained from executing the event.

(8) The present embodiment relates to an information processing method includes: a first parameter updating step for updating a first parameter accumulated in accordance with a usage status of a game; an execution condition determining step for determining whether or not the first parameter satisfies a condition for executing an event; a selection receiving step for receiving selection of an event-targeted game medium when the event is executable; an event executing step for executing the event in association with the event-targeted game medium on a condition that the first parameter is consumed; and a second parameter updating step for updating a second parameter associated with the event-targeted game medium based on a result obtained from executing the event.

In the program, the information processing system, and the information processing method according to the present embodiment described above, a player is caused to select an event-targeted game medium, and the second parameter associated with the event-targeted game medium is updated based on the result obtained from executing the event in association with the event-targeted game medium. In the present embodiment, the first parameter accumulated in accordance with the usage status of the game needs to be consumed for executing the event. Therefore, in the present embodiment, the player can motivated to play the game to accumulate the first parameter for executing the event. In the present embodiment, the second parameter is updated by executing the event. This serves as a trigger for strengthening a new emotional attachment to a game medium less frequently used by the player up to this point, so that an effect where the less-frequently-used game medium is used in the game can be expected thereafter. Accordingly, the present embodiment can proactively motivate the player to play the game by using various game media.

An embodiment of the present invention will be described below. The embodiment to be described below is not intended to unreasonably limit the details of the invention defined in the scope of the claims. Moreover, not all components described in this embodiment need to be essential components of the present invention.

### 1. Configuration of Information Processing System

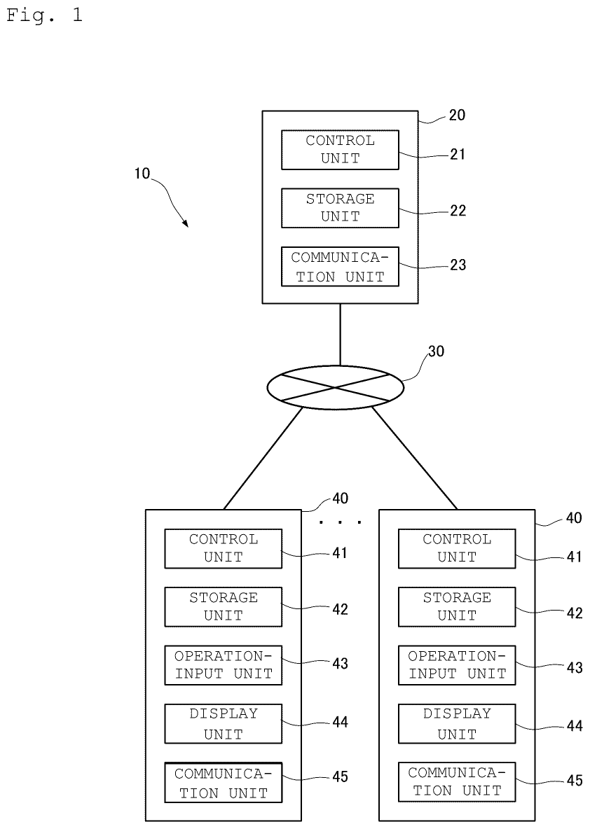

FIG. 1 illustrates the overall configuration of an information processing system 10 according to this embodiment. As shown in FIG. 1, in the information processing system 10, a server 20 and multiple player terminals 40 are connected by a network 30, such as the Internet, a mobile phone network, a LAN, or a WAN, so that a so-called client-server communication system is established. Each of the multiple player terminals 40 exchanges various types of information with the server 20 by communicating therewith via the network 30. Moreover, each of the multiple player terminals 40 exchanges various types of information with another player terminal 40 by communicating therewith via the network 30 or the server 20.

The server 20 includes a control unit 21 constituted of a processor, such as a CPU, a storage unit 22 constituted of a main storage device, such as a ROM or a RAM, and an auxiliary storage device, such as an HDD or an SSD, and a communication unit 23 constituted of a communication module or a communication interface. The server 20 causes the control unit 21 to execute various types of processes in accordance with a program stored in the storage unit 22. The server 20 causes the communication unit 23 to receive information from each player terminal 40 and to transmit, for example, information related to a result of a process executed by the control unit 21 to the player terminal 40.

Each player terminal 40 is, for example, a smartphone, a tablet, a personal computer, a portable game device, or a stationary commercial or household game device. The player terminal 40 includes a control unit 41 constituted of a processor, such as a CPU, a storage unit 42 constituted of a main storage device, such as a ROM or a RAM, and an auxiliary storage device, such as a flash memory, an HDD, or an SDD, an operation-input unit 43 including a touchscreen, a keyboard, and/or a microphone, a display unit 44 constituted of, for example, a liquid crystal display or an organic EL display, and a communication unit 45 constituted of a communication module or a communication interface. The player terminal 40 also executes various types of processes in accordance with a program stored in the storage unit 42. The player terminal 40 receives information from the server 20 via the communication unit 45, and transmits information to the server 20 or another player terminal 40.

The information processing system 10 according to this embodiment has a function for offering a game through each player terminal 40. The game involves raising a character (as an example of a game medium) in the motif of a racehorse and causing the raised character to participate in a race to compete with another character. In particular, the information processing system 10 according to this embodiment has, for example, a raising feature for raising a character, a competition feature for causing the raised character and another character to compete against each other in a race, and a walk event feature for selecting an outing destination with a character and taking a walk thereto. The following description relates to a case where these features are implemented by mainly using each player terminal 40. Alternatively, the aforementioned features may be implemented by mainly using the server 20 or may be implemented by using the server 20 and each player terminal 40 in a shared fashion. Another example of a game medium may be electronic data, including a weapon, equipment, an item, and a card, used in the game.

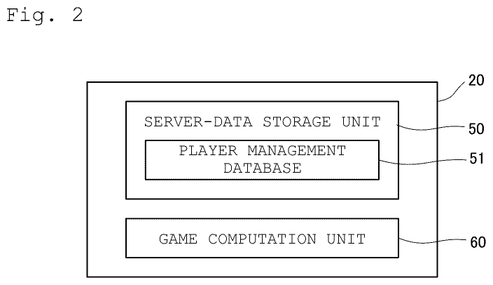

FIG. 2 is a functional block diagram illustrating the main functions of the server 20.

The server 20 in the information processing system 10 has a function for managing, for example, players and characters based on various types of identification information, and a function for performing computation required for proceeding with the game in response to a request from a player terminal 20 and transmitting the computational result to the player terminal 40. These functions are implemented by a server-data storage unit 50 and a game computation unit 60 operating in cooperation with each other.

The server-data storage unit 50 includes a player management database 51 and is mainly implemented by the storage unit 22. In this embodiment, for example, a character list, an item list, and a raising target list are stored in the player management database 51 in association with player IDs given to individual players.

The character list includes, for example, a character individual ID given to each raised character, a character type ID indicating the type of each character, each character's status (reality, score, course aptitude, distance aptitude, running-style aptitude, running style, speed, stamina, power, spirit, wisdom, possessed skill, acquired title), a lock state (locked or unlocked), and each character's raising history (raising condition, record of races participated in during raising).

In this embodiment, the term “raised character” refers to a character that has been raised in accordance with a raising feature as one of the game features, to be described later, implemented by the information processing system 10 according to this embodiment and that is given a set status as a result of completing the raising process.

Although the “character individual ID” and the “character type ID” both exist in this embodiment, the difference therebetween is as follows.

First, a “character individual ID” is an ID given to each raised character when the character has completed the raising process in the raising feature and is registered in the character management database 51, and is used for identifying the raised character associated with a player ID.

In this embodiment, a player selects a raising target from multiple types of characters in the raising feature, and a “character type ID” is an ID given for identifying the type of the character serving as the raising target.

The “lock state” indicates whether or not a transfer of a raised character (deletion from the character list) is prohibited. A transfer is possible in the unlocked state, whereas a transfer is not possible in the locked state. Examples of the locked state include a case where a player has made individual designation from a list of raised characters and a case where a raised character is registered to participate in a race.

The raising target list has stored therein data in which each character type ID is associated with information indicating a released state or an unreleased state. The raising target list also has stored therein data related to an accumulated amount of an affinity parameter (as an example of a second parameter) in association with each character type ID. In this embodiment, a character associated with released information in the raising target list is a character selectable as a raising target in the raising feature by a player. Moreover, in this embodiment, a character is newly releasable by a release item or by a character acquisition lottery, and the number of characters selectable as raising targets by a player varies. In the following, a character selectable as a raising target in the raising feature may sometimes be referred to as a released character.

In detail, for example, the affinity parameter indicates the degree of usage of the same character (game medium) in the entire game. By using the same character in the raising feature and the competition feature, the degree of accumulation of the affinity parameter changes, so that a benefit or a bonus can be generated for the player. In this embodiment, the emotional attachment that the player has to a character can be strengthened in accordance with the affinity parameter, so that the effect of increasing the usage frequency of the entire game can be expected. The affinity parameter is managed for each character in association with the character type ID. Furthermore, for example, the affinity parameter may indicate the degree of usage of a character (game medium) in a specific game feature (e.g., competition feature) among multiple types of game features. Accordingly, the player can ascertain the degree of usage of the specific character related to the specific game feature in accordance with the affinity parameter, whereby a motivation for using the specific character and for using the specific game feature can be given in more finely and effectively.

Furthermore, as information related to the affinity parameter, an affinity rank exists for every character. With regard to the affinity rank, when the accumulated amount of the affinity parameter achieves a condition set for every rank, the affinity rank increases. With regard to the affinity rank, for example, rank 0 to rank 10 may be set at the initial stage for starting the operation of the game, and an upper limit for the affinity rank may be released in accordance with the operation period of the game. The affinity parameter is given to the character used when the condition is satisfied in the raising feature or the competition feature. An increase amount of the affinity parameter based on the usage of the game feature may vary depending on the game result (such as the score or rank). When the affinity rank reaches a predetermined rank as a result of accumulation of the affinity parameter, a story serving as content associated with the character whose affinity rank has reached the predetermined rank is released. The affinity rank serving as a condition for releasing the story may be the same for each character or may be different depending on the character.

The item list includes data related to items, support points, and in-game currency owned by the players. In this embodiment, for example, the details and the amount of items owned, the amount of enhancement points owned, and the amount of in-game currency owned are stored in the item list in the player management database 51.

The items according to this embodiment may be used for supporting the raising process of the characters and for changing the race participation conditions, and can be acquired in accordance with the race results or can be acquired by consuming the in-game currency.

The support points, for example, are used for enhancing support items serving as items for supporting the raising process of the characters. The more a support item is enhanced, the better the raising environment a character can be raised in.

A friend list is stored as data in the player management database 51. In this embodiment, another player can be registered as a friend. In the raising feature, it is possible to rent a character and/or a support item from another player registered as a friend and use the character and/or the support item. Friend registration involves inputting the player ID of another player to a friend registration screen displayed on the display unit 44 of the player terminal 40 and performing a tap input to a register button provided on the friend registration screen if a player corresponding to the player ID exists and can be registered as a friend, whereby the player ID of another player to be registered is added to a friend list. Since there is an upper limit (e.g., 50) for the number of friend registrations for every player and there is also an upper limit (e.g., 100) for the number of registrable friends for every player, new friend registration is possible so long as neither of the upper limits is reached.

The game computation unit 60 performs a process involving executing computation required for proceeding with the game in response to a request from a player terminal 20 and transmitting the computational result to the player terminal 40, as well as a process involving transmitting data required for proceeding with the game to the player terminal 40 in response to a request from the player terminal 20. The game computation unit 60 is mainly implemented by the control unit 41 and the communication unit 45. For example, when receiving a request related to a training command from a player terminal 20 in the raising feature, the game computation unit 60 computes a result indicating whether the training has succeeded or failed, and transmits the computational result to the player terminal 40. Furthermore, for example, when receiving a request related to participation in a race in the raising feature, the game computation unit 60 performs a racing simulation of a race between multiple characters including a character serving as a raising target and a non-player character (NPC), and transmits the result of the racing simulation to the player terminal 40. Moreover, for example, when receiving a request related to participation in a race in the competition feature, the game computation unit 60 performs a racing simulation of a race between multiple characters including a raised character organized by the player and a raised character organized by an opponent, and transmits the result of the racing simulation to the player terminal 40.

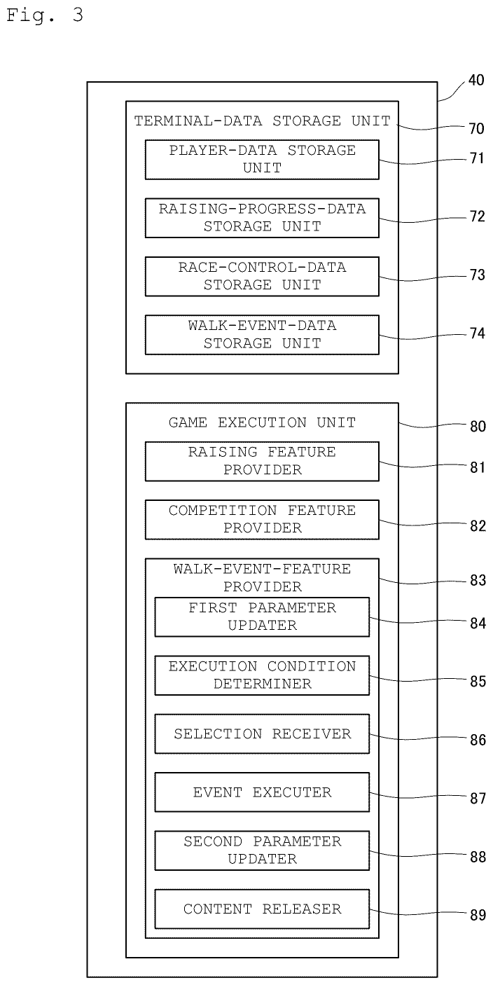

FIG. 3 is a functional block diagram illustrating the main functions of each player terminal 40.

As shown in FIG. 3, in the player terminal 40 in the information processing system 10 according to this embodiment, a terminal-data storage unit 70 and a game execution unit 80 operate in cooperation with each other to implement a raising feature, a competition feature, and an event feature.

The terminal-data storage unit 70 stores data used by the game execution unit 80 for performing various types of processes, and is mainly implemented by the storage unit 42.

The terminal-data storage unit 70 includes a player-data storage unit 71. The player-data storage unit 71 stores therein data related to a character list, raising target list, item list, and friend list corresponding to player IDs. In this embodiment, when an application is activated and terminated, as well as in other necessary situations, a synchronization process related to data (character list, raising target list, item list, and friend list) associated with the player IDs is performed between the player-data storage unit 71 of the player terminal 40 and the player management database 51 and the server 20, and various types of game processes are executed by utilizing the data stored in the player-data storage unit 71. In this embodiment, when the character list, the raising target list, the item list, and the friend list need to be changed in accordance with execution of each type of game process, the stored contents in the player-data storage unit 71 are updated, and the updated stored contents are backed up in the player management database 51 of the server 20, whereby the synchronization of the stored contents is performed therebetween. The data, such as the character list, the raising target list, the item list, and the friend list, associated with the player IDs may be downloaded to the player-data storage unit 71 from the player management database 51 where necessary, such as when the application is activated.

The terminal-data storage unit 70 also includes a raising-progress-data storage unit 72. The raising-progress-data storage unit 72 stores therein data (raising progress data) required for the progress of the raising feature of a character (i.e., a character with a character type ID associated with released information in the raising target list) selectable as a raising target in the raising feature. In this embodiment, for example, a game event and a raising goal related to the raising feature are prepared for every character, and the raising progress data at least containing the set contents of the raising goal and the set contents of the game event is stored in the raising-progress-data storage unit 72 in association with the character type ID.

The terminal-data storage unit 70 further includes a race-control-data storage unit 73. The race-control-data storage unit 73 stores therein data for controlling the movement of each character and effect display of an activated skill, as well as text data and audio data of race commentary, when the race in which the character has participated in the raising feature or the competition feature is to be watched.

The terminal-data storage unit 70 also includes a walk-event-data storage unit 74. The walk-event-data storage unit 74 stores therein various types of data for performing control related to the walk event feature. In this embodiment, examples of data stored in the walk-event-data storage unit 74 include data related to a period in which a walk event is held, management data of a walk parameter (as an example of a first parameter) associated with each player ID, data for setting an increase amount of the walk parameter, data related to a background image and a character motion for effect display during execution of the event, data for setting an increase amount of the affinity parameter, data for managing a reward acquisition condition, and management data related to releasing of content.

The game execution unit 80 executes, for example, a process for starting the game when a game starting condition is satisfied, a process for executing a game mode selected from multiple types of game modes, a process for proceeding with the game, a process for causing an event to occur when an event occurring condition is satisfied, a process for computing a game result, a process for terminating the game when a game terminating condition is satisfied, a process for requesting the server 20 to perform computation, a process for acquiring the computational result and necessary data from the server 20, and a process for transmitting a computational result and data of each player terminal 40 to the server 20, and is mainly implemented by the control unit 41 and the communication unit 45. In this embodiment, the game execution unit 80 includes a raising feature provider 81, a competition feature provider 82, and a walk-event-feature provider 83.

The raising feature provider 81 performs a process involving providing the raising feature for raising a character. In this embodiment, an input related to a raising process of a specific released character is received, and the computational result with respect to the input is displayed.

In this embodiment, when the released character corresponding to the received input is to be raised in the raising feature, it is desired that an action serving as a target for turn consumption be selected for every turn. Examples of an action serving as a target for turn consumption include training, participation in a race, an outing, and a health room. The raising feature provider 81 receives the selection of the action serving as a target for turn consumption via a raising home screen displayed on the display unit 44, and requests the server 20 to compute a result with respect to the selected action. The server 20 having received the request computes the result with respect to the selected action and transmits the computational result to the player terminal 40. The raising feature provider 81 causes the display unit 44 to display a display screen corresponding to the computational result received from the server 20.

In this embodiment, a raising goal is set in accordance with the type of released character serving as a raising target. In the raising goal, there may sometimes be a mandatory action where selection is forced during a predetermined turn. An example of the raising goal is participation in a predetermined race or a predetermined race placement obtained in a predetermined race. In this case, during a turn in which the predetermined race associated with the raising goal is set, participation in the race is the mandatory action, and the action serving as a target for turn consumption other than the participation in the race is not selectable. Accordingly, the raising feature provider 81 performs control for limiting the selection of an action different from the mandatory action during the turn for receiving the selection of the mandatory action.

When the raising process of the released character in the raising feature is completed, the raising feature provider 81 performs control for updating the affinity parameter by an increase amount corresponding to the end of one raising process. For example, an increase amount acquired in the current raising process is added to the affinity parameter associated with the character type ID corresponding to the completed raising process. The increase amount of the affinity parameter in the raising feature may change depending on the raising result (e.g., score). When the affinity parameter reaches a predetermined amount, the affinity rank may be updated to the rank at the next level, and a predetermined effect may be executed.

The competition feature provider 82 performs a process involving providing the competition feature for causing a raised character owned by the player to compete with a raised character of another player or with a non-player character (NPC) in a race.

In this embodiment, the types of races that can be used as the competition feature by the player include three types, which are a team arena, a daily race, and a daily legend race.

A team arena is a competition feature involving organizing five teams corresponding to five types of distance categories, which are a short distance, a mile, a mid-distance, a long distance, and a dirt racetrack, and each including three characters selected from the raised characters owned by the player, and causing the five teams to compete with teams organized by another player in five types of races related to the respective distance categories. The team to which the character that has finished first in each distance category belongs wins, and a victory against the opponent is obtained by winning three of the five types of races. In the team arena, arena points according to the behaviors and the race placements of the characters in each race are given. The player's rank is determined in accordance with the total sum of the arena points in the five types of races, and a reward according to the rank is given.

A daily race is a competition feature involving preparing races with different rewards and different difficulty levels with respect to the distance category of mile or mid-distance, selecting one character from the raised characters owned by the player, and causing the selected raised character to participate in a race and compete with a non-player character (NPC) in the race. In the daily race, a reward according to the race placement in the race in which the raised character is made to participate in by the player can be acquired.

A daily legend race is a competition feature in which a character piece can be acquired as a reward in accordance with the result of the race. A character piece is an item that enables releasing of an unreleased character as a raising target or that enables an increase in the rarity level of a released character by consuming a predetermined number of character pieces. In the daily legend race, the conditions for the race are set for each character. The daily legend race involves selecting a character for which acquisition of a character piece is desired, selecting one character from the raised characters owned by the player, and causing the selected raised character to participate in the race. In the daily legend race, when the raised character made to participate in the race by the player acquires first place in the race, the character piece of the character corresponding to the race that the raised character has participated in can be acquired.

If the player selects participation in one of the competition features of the team arena, the daily race, and the daily legend race, the competition feature provider 82 transmits a competition result request to the server 20. The server 20 that has received the competition result request from the player terminal 40 executes a racing simulation of the race, and the competition feature provider 82 acquires the result of the racing simulation from the server 20. In the player terminal 40 that has received the result of the racing simulation from the server 20, the competition feature provider 82 generates a race video based on the result of the racing simulation and causes the display unit 44 to display the generated race video on the basis of various types of data stored in the race-control-data storage unit 73, so that the player can watch the details of the race.

When the raised character owned by the player is caused to participate in the race in the competition feature, the competition feature provider 82 updates the affinity parameter of the released character corresponding to the participating raised character by an increase amount corresponding to one race participation. The increase amount of the affinity parameter based on the usage of the competition feature may change depending on the race result (at least one of the race placement and the race outcome).

The walk-event-feature provider 83 performs a walk-event-feature providing process involving causing the player to select an arbitrary released character and executing a walk event corresponding to the selected released character so that a bonus including a reward, such as an item, or an increase in affinity parameter can be acquired. In this embodiment, the walk-event-feature provider 83 includes a first parameter updater 84, an execution condition determiner 85, a selection receiver 86, an event executer 87, a second parameter updater 88, and a content releaser 89.

The first parameter updater 84 performs a process for updating the walk parameter accumulated in accordance with the usage status of the game.

The first parameter updater 84 updates the walk parameter in association with a log-in to the game. In this embodiment, log-in of the player is managed in log-in management cycles where 5:00 AM to 4:59 AM on the following day is defined as one day. The first parameter updater 84 updates the walk parameter to a maximum value (e.g., 10) at the time of the first log-in of each day during the period in which the walk event is held.

The first parameter updater 84 updates the walk parameter in association with the usage of the raising feature and the usage of the competition feature. In this embodiment, in each of a case where the raising process of a character is completed, a case where a competition is performed in the team arena, a case where a competition is performed in the daily race, and a case where a competition is performed in the daily legend race, a predetermined value is accumulated as the walk parameter in accordance with the used game feature for every single use of a principal game feature. Specifically, the increase amount of the walk parameter according to the use of the principal game feature varies depending on the type of the game feature used. By varying the increase amount of the walk parameter in accordance with the game feature used by the player in this manner, the player can be motivated to use various game features. Alternatively, the increase amount of the walk parameter as a result of using each game feature may be the same. When the walk parameter is a maximum value, if the timing for updating the walk parameter is reached, the walk parameter is prevented from being accumulated beyond the maximum value. Providing a limit in this manner prevents the walk parameter from being accumulated beyond the maximum value, and can prevent a large difference from occurring between players. Furthermore, for example, the first parameter may be updated when a condition where a predetermined mission related to the principal game feature is achieved, such as when a specific race is performed three times in the competition feature (when a specific stage is cleared, when an enemy is eliminated a predetermined number of times, or a combination thereof in an example of another game). Moreover, for example, the first parameter may be accumulated by using an item. The item may be acquired by various methods, such as by paying, purchasing with in-game currency, and using each feature.

The principal game features in this embodiment refers to a game provided by the raising feature provider 81 and involving raising a character (as an example of a game medium) in the motif of a racehorse, and a game provided by the competition feature provider 82 and involving causing a raised character to participate in a race and compete with another character (including a raised character of another player and a non-player character (NPC)). The principal game feature is a game feature mainly used by the player due to the nature of the targeted game. With regard to examples of other games, a game for raising players or a team and a game for performing a match by using the raised players or team each correspond to the principal game feature as a game feature in a game related to baseball or soccer. Furthermore, for example, in the case of a card game, a game corresponding to the principal game feature involves upgrading cards by enhancing and evolving them and performing a competition by organizing a deck using the upgraded cards. Moreover, for example, in the case of a romance game, a series of flow corresponding to the principal game feature involves establishing a predetermined relationship with a specific person of the opposite sex through interactions, such as dates, to provide a simulated romantic experience.

The first parameter updater 84 resets the walk parameter to an initial value (e.g., 0) at a reset timing that periodically occurs once every 24 hours. In this embodiment, the walk parameter of each player is reset to the initial value at every predetermined time point (5:00 AM) as the reset timing occurring every time a day (from 5:00 AM to 4:59 AM on the following day) synchronizing with the log-in management cycle passes. Although the walk parameter as the first parameter is updated to the maximum value at the time of the first log-in and is reset to the initial value in log-in management cycles, the configuration is not limited to this. Instead of providing the upper limit and resetting the first parameter in cycles, the first parameter may be accumulated. Accordingly, a game feature with a completion element can be provided to the player.

The execution condition determiner 85 performs a process for determining whether or not the walk parameter has satisfied a condition for executing a walk event. In this embodiment, it is determined whether or not the condition for executing a walk event is satisfied based on whether or not the walk parameter is a maximum value. In this embodiment, a limit is provided to the number of times the walk event is executable, and is twice per day. Providing a limit to the number of times the walk event is executable in this manner prompts the player to log in continuously, and can prevent a large difference from occurring between players.

The selection receiver 86 performs a process for receiving selection of an event-targeted character when a walk event is executable. In this embodiment, the selection receiver 86 allows the completion status of the walk event for each character to be visually recognizable on an input interface that receives the selection of the event-targeted character. In detail, a character selection dialog is displayed on the display unit 44 and is configured to receive the selection related to the event-targeted character. The selection receiver 86 displays a list of released characters associated with player IDs on the character selection dialog and allows the completion status of the destination of each character to be visually recognizable in a display mode using a destination icon. On the condition that the affinity rank reaches a predetermined rank, a released character that can be selected as an event-targeted character may be limited. For example, if there is a released character whose affinity rank has reached the upper limit, control for not displaying the relevant released character on the input interface that receives the selection of the event-targeted character may be performed, or control for not allowing the relevant released character to be selectable on the input interface that receives the selection of the event-targeted character may be performed.

In this embodiment, multiple types of walk events with different effect contents according to destinations are executable by selecting any of multiple types of destinations for each character. The selection receiver 86 displays a destination selection dialog on the display unit 44 after an event-targeted character is selected, and receives selection of the effect contents of a walk event serving as an execution target.

In this embodiment, a reward can be acquired in association with execution of a walk event. The player can select and acquire a single kind of reward every time a single walk event is executed. Accordingly, by being able to obtain a reward by executing a walk event, the player can be given a motivation for executing a walk event. In this embodiment, a motivation for executing the principal game feature to accumulate the walk parameter can be given. After the destination for the walk event to be executed is selected, the selection receiver 86 displays a reward selection dialog on the display unit 44 and receives selection of a reward. In this embodiment, with regard to rewards that can be acquired in the execution of walk events, each reward is managed based on a reward ID and can be acquired only once per reward ID. Thus, the walk-event-data storage unit 74 has stored therein reward management data to which an acquired flag is settable in association with a reward ID. When a walk event is executed, an acquired flag is set to a reward ID selected by the player. The selection receiver 86 checks the setting status of the acquired flag in each reward ID in the reward management data, and varies the display mode of a non-acquired reward and the display mode of an acquired reward from each other on the reward selection dialog, thereby making the non-acquired reward visually recognizable. In this embodiment, a reward (such as an item) acquired in a walk event is reflected and managed on the item list of the player-data storage unit 71.

The event executer 87 performs a process for executing a walk-event-related effect in association with the event-targeted character. In this embodiment, the walk-event-related effect executed is an animation effect involving combining a background image according to the destination with a character image based on character motion data to generate an effect image and displaying the effect image on the display unit 44. Specifically, the event executer 87 performs a process for executing a walk-event-related animation effect according to a combination of an event-targeted character and a destination selected as an execution target. In this embodiment, the animation effect executed through the walk event is a special effect related to a specific released character, thereby further strengthening the emotional attachment to the released character. When the walk-event-related animation effect is executed, the animation effect may be varied with a certain probability. In detail, for example, in the case of a meal-related walk event, a success effect where a meal is successfully finished and a failure effect where a meal cannot be finished may be provided. Moreover, the reward acquirable by the player or the degree of increase or decrease of the affinity parameter may be varied between the case where the success effect is executed and the case where the failure effect is executed.

The second parameter updater 88 updates the affinity parameter associated with the event-targeted character based on a result obtained from executing the walk event. In this embodiment, the update is performed such that the affinity parameter associated with the character type ID of the released character serving as the event-targeted character increases with a fixed increase amount every time a single walk event is executed. The increase amount of the affinity parameter may be varied in accordance with the type of the executed walk event, that is, the destination selected by the player. Furthermore, the increase amount of the affinity parameter may be set in accordance with the combination of the character and the destination.

The content releaser 89 performs a process for releasing content associated with the event-targeted character based on a result obtained from executing the walk event. In this embodiment, the walk-event-data storage unit 74 has stored therein content-release-status data used for managing the content release status of each character. In the content-release-status data, an effect ID for identifying the walk-event-related animation effect according to the destination and a released flag indicating the release status of each effect ID are stored in association with the character type ID indicating the type of character. When the walk-event-related animation effect is executed, the content releaser 89 checks whether or not the effect ID related to the animation effect is released based on the content-release-status data. If the content releaser 89 determines that the animation effect is in an unreleased status (does not have a released flag set therein), the content releaser 89 releases the animation effect by setting a released flag with respect to the effect ID, so that the animation effect can be viewed freely by the player.

The content releaser 89 performs a process for releasing content associated with the event-targeted character when the affinity parameter satisfies a predetermined condition. In this embodiment, a story constituted of multiple episodes is prepared for each character. When the affinity parameter satisfies a condition for releasing the story, the content releaser 89 performs a process for releasing the story in a stepwise fashion to make the story viewable. The content released based on the affinity parameter is not limited to the story of each character. Examples include releasing profile information about the character and making the profile information viewable when the affinity parameter satisfies the releasing condition, releasing the character's voice and making the character's voice listenable when the affinity parameter satisfies the releasing condition, and releasing the character's costumes and making the outer appearance of the character changeable when the affinity parameter satisfies the releasing condition. The function for releasing the content based on the affinity parameter may be independent from the walk-event-feature provider 83. For example, the game execution unit 80 may be additionally provided with an affinity-related-content releaser separately from the raising feature provider 81, the competition feature provider 82, and the walk-event-feature provider 83. On the condition that the affinity rank based on the affinity parameter achieves a predetermined rank, the affinity-related-content releaser performs a process for releasing the content corresponding to the achieved affinity rank in association with the character type ID of the released character.

### 2. Control Method According to This Embodiment

The following description of a control method according to this embodiment relates to an example where a game program according to this embodiment is applied to a game application of each player terminal 40 provided as a smartphone. A specific control process is implemented by the main features of the server 20 and each player terminal 40 mentioned above. Alternatively, the specific control process may be implemented by mainly using the feature of the server 20 or may be implemented by using the features of the server 20 and each player terminal 40 in a shared fashion.

The game program according to this embodiment is capable of providing multiple types of game features. In the raising feature serving as a principal game feature, a character serving as a raising target is selected from multiple types of characters, the status changes in accordance with the progress of the game, the status of the character is confirmed when a predetermined terminating function is satisfied, and the raising process ends. The raised character can be used for competing in a race against a character raised by another player or against a non-player character (NPC) in the competition feature serving as another principal game feature.

The information processing system 10 to which the game program according to this embodiment is applied is configured to use the raising feature and the competition feature to accumulate the affinity parameter in association with the character used in each game feature. In detail, the affinity parameter is individually managed in association with the character type ID of each released character. When the raising feature is used, the affinity parameter of the released character corresponding to the character serving as the raising target is accumulated at the end of the raising process. When the competition feature (race arena, daily race, or daily legend race) is used, the affinity parameter of the released character corresponding to the raised character that has participated in the race is accumulated after the end of the competition. Accordingly, in this embodiment, the affinity parameter serves as an indicator indicating the degree of usage of a character, is accumulated in association with the multiple types of game features, and is shared by the released characters owned by the player.

In this embodiment, as the accumulation of the affinity parameter progresses, the content prepared for each character can be released. In detail, a story constituted of seven episodes is prepared for each character. The first to fourth episodes are released initially regardless of the affinity parameter. For the fifth episode and onward, a releasing condition according to the affinity parameter is set for each episode. When the affinity parameter satisfies the releasing condition of the story, the fifth episodes and onward of the story are released in a stepwise fashion so that the story becomes viewable.

Accordingly, in this embodiment, the affinity parameter associated with the character used by utilizing the raising feature or the competition feature can be accumulated. However, since there is a flow of raising a character in the raising feature and using the raised character in the competition feature, bias tends to occur in the character used by the player. As a result, there is also a tendency for bias to occur between characters with respect to the degree of accumulation of the affinity parameter. While releasing of content and granting of a bonus may progress for a character favored by the player, a situation may occur where such releasing of content stagnates for a character owned as a released character but used less frequently. With the principal game features alone, the player focuses on the specific results of the raising feature and the competition feature, thus lowering the usage frequency and the level of interest in the affinity parameter serving as a parameter indicating the degree of usage of a specific character. This is problematic in that the mechanism for using a wide range of characters (as an example of game media) and for strengthening the emotional attachment to the entire game is difficult to function properly.

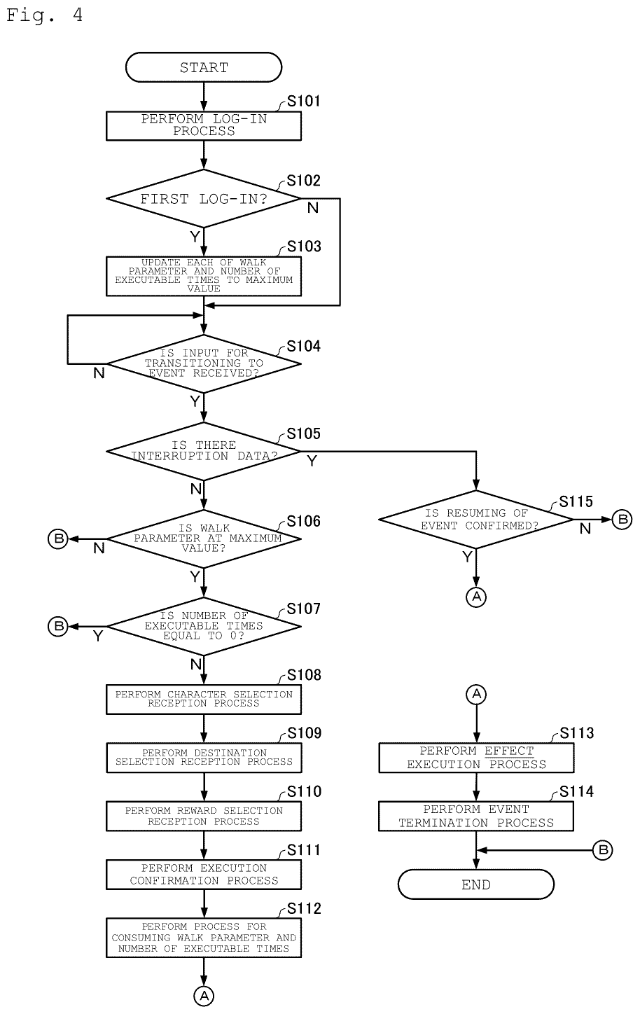

In this embodiment, the method employed involves executing a walk event by consuming the walk parameter accumulated in accordance with the usage status of the game, so that the affinity parameter associated with the character selected by the player can be accumulated. With this method, a motivation to use a wide range of characters (as an example of game media) can be expected, and by extension, the effect for strengthening the emotional attachment to the entire game can be expected. The following description relates to the flow of a walk-event-related process with reference to a flowchart shown in FIG. 4.

First, when the game application is activated, a log-in process is performed (step S101). In the log-in process, the player terminal 40 requests the server 20 to authenticate the account of the player associated with the player ID. When the account authentication based on the player ID is completed in the server 20, a log-in permission response is acquired from the server 20.

If the current log-in is the first log-in of log-in management cycles (a period from 5:00 AM to 4:59 AM on the following day will be referred to as a log-in management cycle hereinafter) (Y in step S102), the walk parameter and the number of executable times are each updated to a maximum value (step S103). In this embodiment, the walk parameter is reset to an initial value (e.g., 0) at 5:00 AM every day as a reset timing that synchronizes with the log-in management cycle, and from the first log-in thereafter, the walk parameter is updated to the maximum value (e.g., 10). With regard to the number of times the walk event is executable, the number of executable times is reset to an initial value (e.g., 0) at 5:00 AM every day as a reset timing that synchronizes with the log-in management cycle, and from the first log-in thereafter, the number of executable times is updated to the maximum value (e.g., 2). Specifically, a walk event is always executable immediately after the first log-in of each day. Alternatively, during the first log-in of the log-in management cycles, the walk parameter and the number of executable times may be updated so as to be overwritten to the respective maximum values. Accordingly, in this embodiment, the walk parameter is updated to the maximum value during the first log-in, so that the player can be prompted to perform a log-in process on a daily basis.

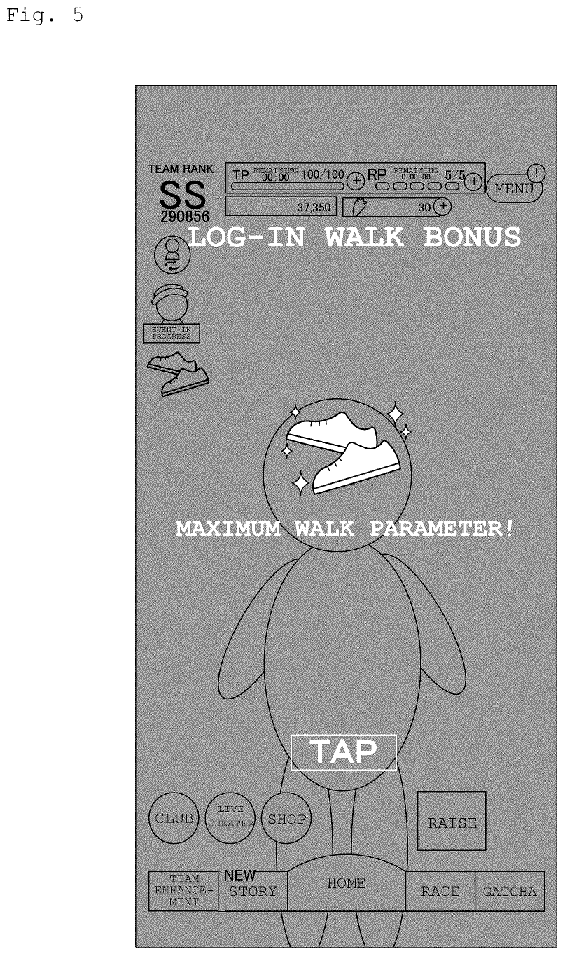

In this embodiment, a home screen is displayed upon completion of the log-in process. However, in the case of the first log-in of the log-in management cycles, first display for providing a notification that the walk parameter has been updated to the maximum value is performed, as shown in FIG. 5. The first display allows the player to effectively acknowledge that the walk parameter is at the maximum value, and can efficiently encourage the player to participate in the walk event.

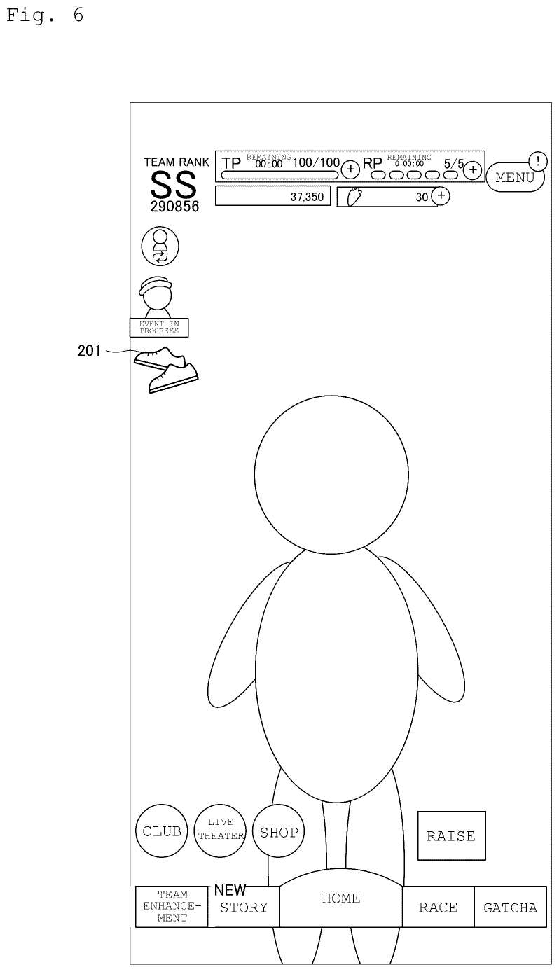

As shown in FIG. 6, the home screen displays an event icon 201. The event icon 201 also serves as an input button for invoking a character selection dialog, to be described later. In this embodiment, the accumulation status of the walk parameter can be ascertained based on the display mode of the event icon 201. If the walk parameter is at the maximum value, the event icon 201 is displayed in a highlighted fashion. A gauge may be displayed on the home screen to indicate the degree of accumulation of the walk parameter. Accordingly, in this embodiment, the event icon 201 on the home screen allows the accumulation status of the walk parameter to be ascertainable, and also functions as an input button, thereby achieving enhanced viewability and operability.

When a tap input (event transition input) is performed on the event icon 201 while the home screen is being displayed (Y in step S104), a check is performed to determine whether there is interruption data of the walk event (step S105). In this embodiment, if the walk-event-related process being executed is interrupted due to, for example, a task kill or a communication error while a walk-event-related effect is being executed, the walk-event-related process can be resumed from the interrupted state. An event resuming process when there is interruption data will be described later.

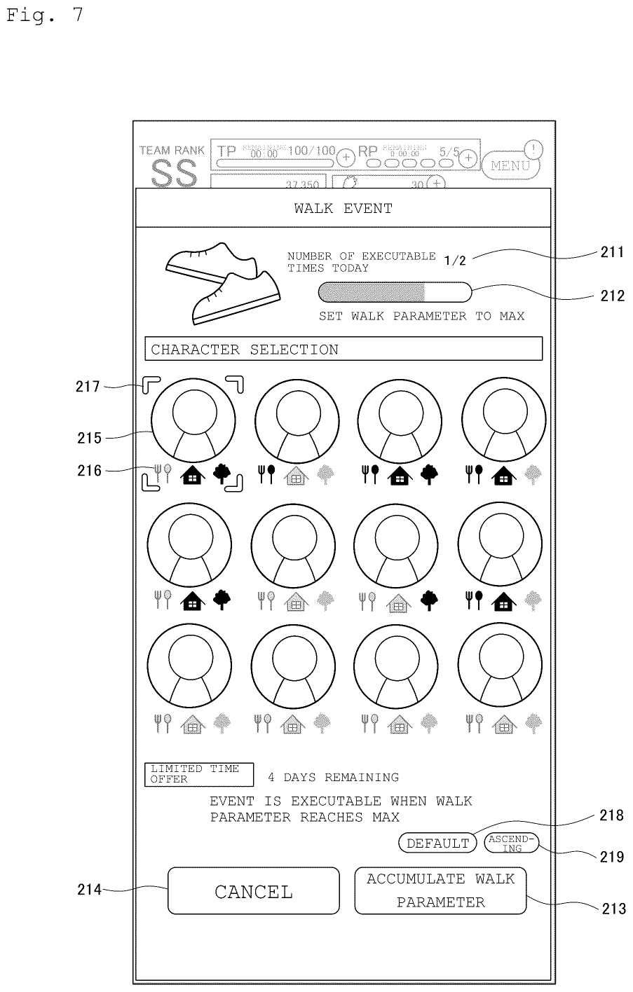

If there is no interruption data with respect to the walk event (N in step S105), a character selection dialog is displayed, as shown in FIG. 7. The character selection dialog is provided with a number-of-executable-times display field 211 and a walk gauge 212. The number of times the walk event is executable can be checked in accordance with the number-of-executable-times display field 211, and the accumulation status of the walk parameter can be checked in accordance with the walk gauge 212.

When the character selection dialog is displayed, a check is performed to determine whether or not the walk parameter satisfies a condition for executing the walk event (step S106). In this embodiment, it is determined that the condition for executing the walk event is satisfied when the walk parameter is at the maximum value. When the walk parameter is at the maximum value (Y in step S106), a check is performed to determine whether or not the remaining number of times the walk event is executable is available (step S107).

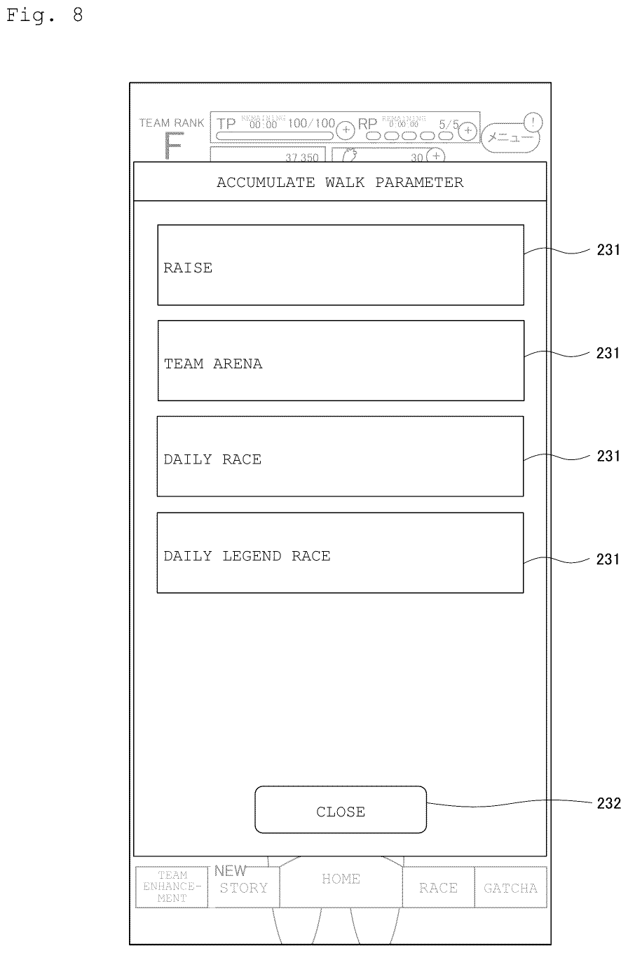

As shown in FIG. 7, in this embodiment, if the walk parameter is not at the maximum value, the walk event is not executable since a confirm button 220, to be described later, is not displayed, but the character selection dialog is provided with a guide button 213. When a tap input is performed on the guide button 213, a feature guide dialog for guiding to the raising feature and the competition feature that enable accumulation of the walk parameter is displayed, as shown in FIG. 8. Accordingly, in this embodiment, through the feature guide dialog, the player can instantly ascertain the principal game features that enable accumulation of the walk parameter. By performing a tap input on any of transition buttons 231 corresponding to the game features provided on the feature guide dialog, the selected game feature can be used immediately. When a tap input is performed on a close button 232 provided on the feature guide dialog, the character selection dialog in FIG. 7 is recovered. In this embodiment, if the walk parameter does not satisfy the condition for executing the walk event, control for guiding to the principal game feature (the raising feature or the competition feature) is performed, so that an effect for efficiently increasing the affinity parameter (common character parameter) can be expected while giving further enjoyment to the player and also while enhancing the motivation to play the principal game feature. Consequently, the emotional attachment to the released character can be further strengthened.

If the walk parameter is at the maximum value and the remaining number of times the walk event is executable is available (Y in step S106 and N in step $107), reception of selection related to an event-targeted character is permitted, and a character selection reception process is executed (step S108).

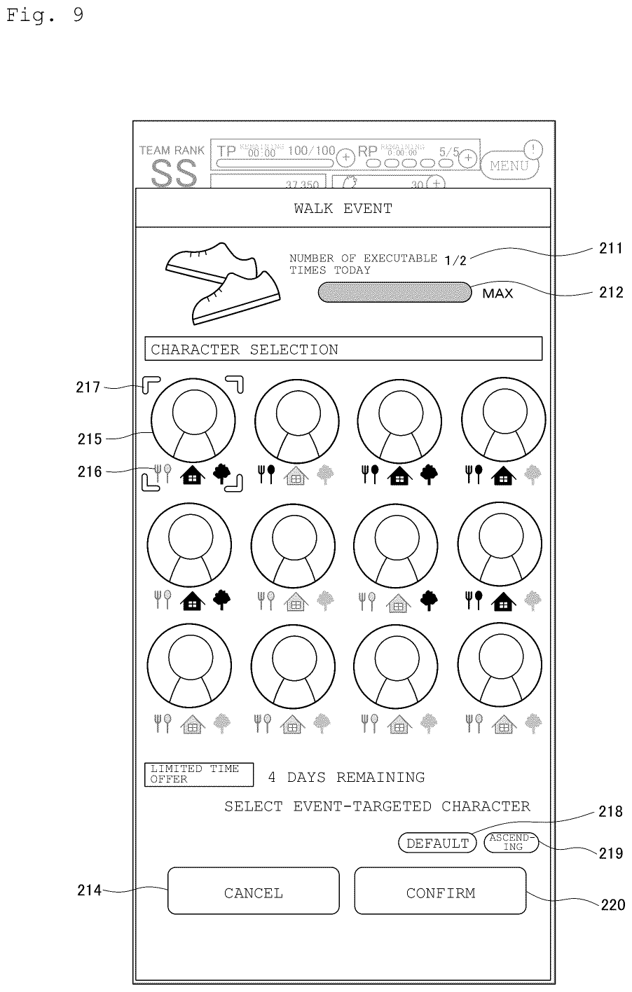

In this embodiment, when reception of selection related to an event-targeted character is possible, selection of an event-targeted character is received through the character selection dialog invoked via the event icon 201 on the home screen, as shown in FIG. 9. On the character selection dialog, a list of characters as selectable candidates is displayed by using character icons 215. The characters serving as selectable candidates are released characters that are characters with released flags set in a character list associated with the player. On the character selection dialog, three types of destinations are displayed as destination icons 216 in correspondence therewith below each character icon 215. In detail, a fork-and-spoon icon indicates a meal event, a house icon indicates an indoor event, and a tree icon indicates an outdoor event, but the icons are not limited thereto. Each of the destination icons 216 visually indicates an event completion status of each character, such that a destination icon 216 corresponding to a destination where the walk event has already been executed is displayed in color, whereas a destination icon 216 corresponding to a destination where the walk event has not been executed is grayed out.

On the character selection dialog, a selected mark 217 is given to the selected character icon 215. By performing a tap input on another character icon 215, the selected mark 217 is given to the newly-selected character icon 215, whereby the selected character is changed. In this embodiment, when the character selection dialog is invoked, the selected mark 217 is given to the character icon 215 of the character at the top of the sort order (i.e., the character displayed most leftward at the top level) as default. In this embodiment, the character selected when the character selection dialog is being invoked will be referred to as an initially-selected character hereinafter.

If the walk event has already been experienced, selection information about the previous event-targeted character may be maintained, and the relevant character may be set as the initially-selected character. Alternatively, the character at the top of the sort order among characters with uncompleted events may be set as the initially-selected character.

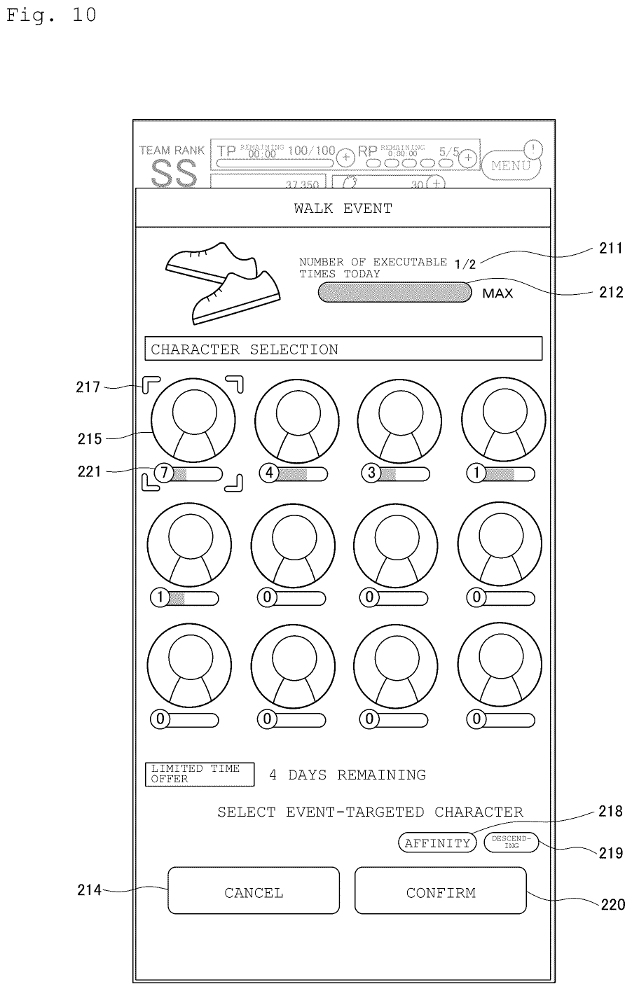

The sort target can be changed by performing a tap input on a sort-target change button 218 provided on the character selection dialog. The ascending order and the descending order can be switched therebetween by performing a tap input on a sort-order change button 219 provided on the character selection dialog. In this embodiment, selectable sort targets include “affinity” in addition to “default”. When “affinity” is selected as the sort target, as shown in FIG. 10, the character icons 215 are sorted in the order of affinity parameters associated with released characters, and an affinity gauge 221 is displayed in place of the destination icons 216 below each character icon 215. The affinity gauge 221 visually indicates the affinity rank (0 to MAX) determined in accordance with the accumulated amount of the affinity parameter, as well as the degree of accumulation of the affinity parameter from the current affinity rank to the next affinity rank. Accordingly, the player can compare the affinity gauges 221 of the released characters and execute the walk event to increase the affinity parameter of a specific released character. Furthermore, in order to enhance the viewability and operability with respect to the selection of an event-targeted character, the character selection dialog may be provided with a filtering function. For example, the character selection dialog may display only a character designated in accordance with the effect release status of the walk event (entirely released or partially unreleased) or the accumulation status of the affinity parameter (the affinity parameter is below the maximum value or the affinity parameter is at the maximum value).

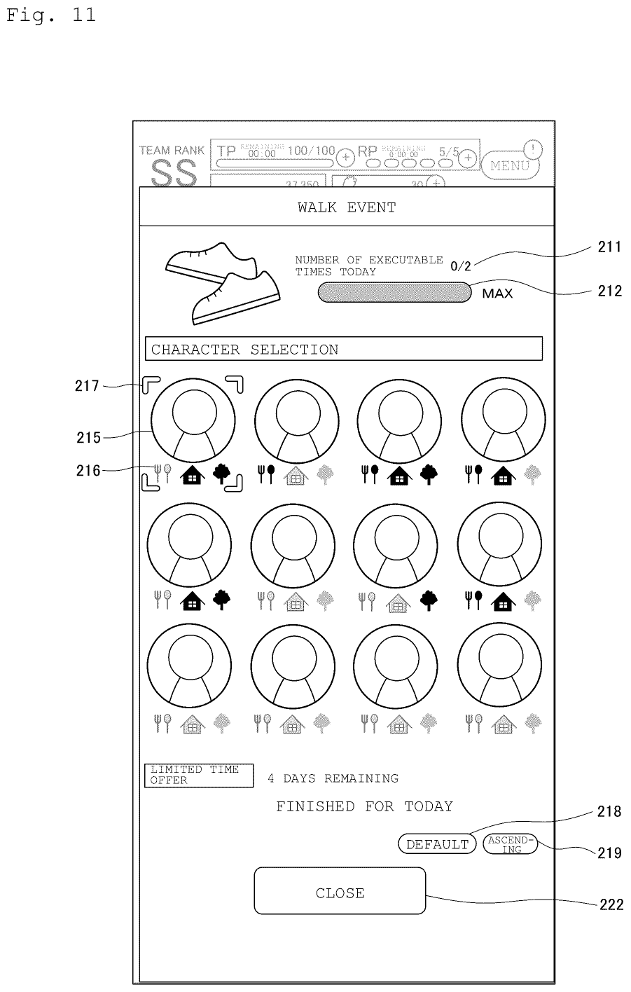

As shown in FIGS. 9 and 10, when selection of an event-targeted character is receivable, the character selection dialog is provided with the confirm button 220. When a tap input is performed on the confirm button 220, the character corresponding to the character icon 215 given the selected mark 217 is set as an event-targeted character, and a destination selection reception process for selecting a destination is performed (step S109). When a tap input is performed on a cancel button 214 while the character selection dialog is being displayed, the character selection dialog is closed and the home screen is recovered. In this embodiment, if the number of times the walk event is executable is 0 even if the walk parameter is at the maximum value, a notification message indicating that the number of executable times for today has been completed is displayed on the character selection dialog while a close button 222 is displayed, as shown in FIG. 11. When a tap input is performed on the close button 222, the character selection dialog is closed and the home screen is recovered.

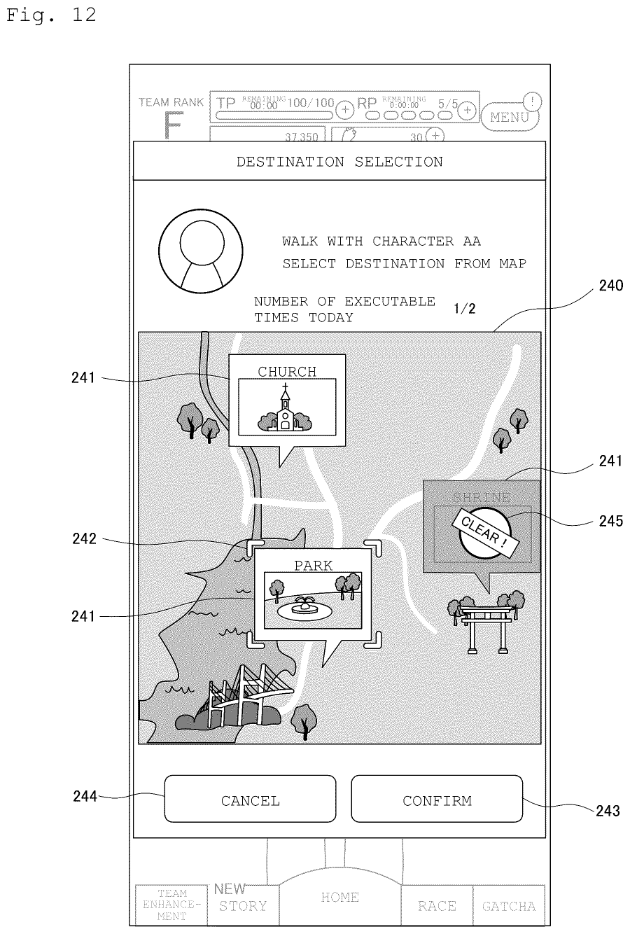

The destination selection reception process involves receiving selection of a destination through the destination selection dialog. As shown in FIG. 12, on the destination selection dialog, a map image 240 is displayed, and destination images 241 corresponding to three types of destinations are displayed over the map image 240. By performing a tap input on any of the destination images 241, an arbitrary destination can be selected. The destination image 241 corresponding to the selected destination is given a selected mark 242. A destination image 241 corresponding to a destination where the walk event has already been executed is grayed out and is given a cleared mark 245, so as to be ascertainable that the walk event has already been executed.

The destination selection dialog is also provided with a confirm button 243 and a cancel button 244. When a tap input is performed on the confirm button 243, the destination corresponding to the destination image 241 given the select mark 242 is set as an execution target for the walk event, and a reward selection reception process for selecting a reward is performed (step S110). When a tap input is performed on the cancel button 244 while the destination selection dialog is being displayed, the destination selection dialog is closed and the character selection dialog in FIG. 9 or 10 is recovered.

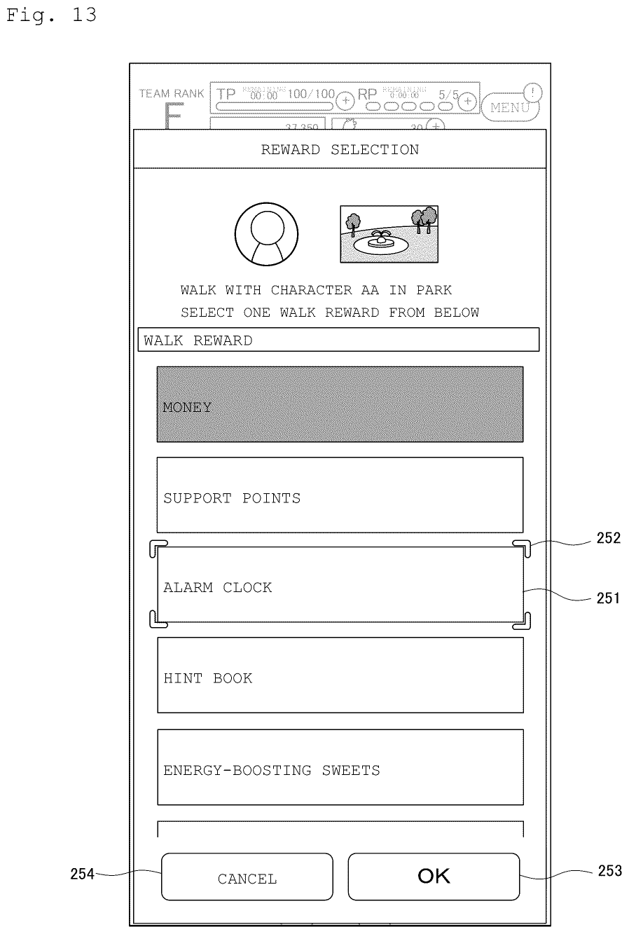

The reward selection reception process involves receiving selection of a reward through the reward selection dialog. As shown in FIG. 13, the reward selection dialog displays a list of rewards acquirable in the walk event being held. By performing a tap input on a reward button 251, an arbitrary reward can be selected. The reward button 251 corresponding to the selected reward is given a selected mark 252. In this embodiment, each reward is acquirable only once, and the reward button 251 of the acquired reward is grayed out on the reward selection dialog. In a state where a normally-displayed reward button 251 is selected, a tap input to a confirm button 253 is enabled. In a state where a grayed-out reward button 251 is selected, a tap input to the confirm button 253 is disabled. In the state where a tap input to the confirm button 253 on the reward selection dialog is disabled, the confirm button 253 is grayed out. When a tap input is performed on a cancel button 254 in a state where the reward selection dialog is displayed, the reward selection dialog is closed and the destination selection dialog is recovered. With regard to the acquisition of a reward, the same reward may be acquirable multiple times, and the number of times a reward is acquirable does not have to be provided with a limit.

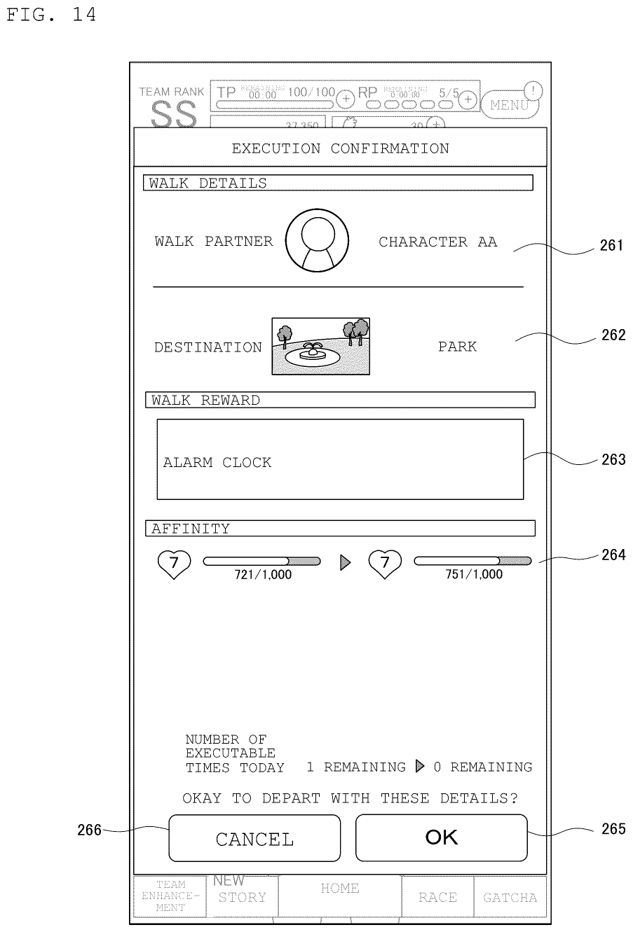

When a tap input is performed on the confirm button 253 while an acquirable reward is selected in a case where the reward selection dialog is displayed, an execution confirmation process is performed (step S111). As shown in FIG. 14, the execution confirmation process involves displaying an execution confirmation dialog and performing final confirmation about the execution details of the walk event.

On the execution confirmation dialog, the player's selection results in the character selection reception process, the destination selection reception process, and the reward selection reception process are reflected, and the execution details of the walk event are displayed. In detail, the character corresponding to the event-targeted character is displayed in a selected-character display field 261, the destination as the execution target for the walk event is displayed in a selected-destination display field 262, and the reward to be acquired by executing the walk event is displayed in a selected-reward display field 263. In this embodiment, the affinity parameter associated with the released character corresponding to the event-targeted character is also accumulated as a result of executing the walk event, and the degree of change in the affinity parameter before and after the execution of the walk event is displayed in an affinity change display field 264.

When a tap input is performed on a confirm button 265 while the execution confirmation dialog is being displayed, the execution details of the walk event are confirmed. After a process for consuming the walk parameter and the number of times the walk event is executable is executed (step S112), an effect execution process is performed in accordance with the confirmed execution details of the walk event (step S113). When a tap input is performed on a cancel button 266 while the execution confirmation dialog is being displayed, the execution confirmation dialog is closed and the reward selection dialog is recovered.

The process for consuming the walk parameter and the number of times the walk event is executable involves updating the walk parameter to an initial value (e.g., 0) and subtracting 1 from the number of times the walk event is executable. With regard to the number of times the walk event is executable, the number of executions of the walk event may be managed for each player, and it may be determined that the number of executable times has been completely consumed when the number of executions becomes equal to the number of executable times.

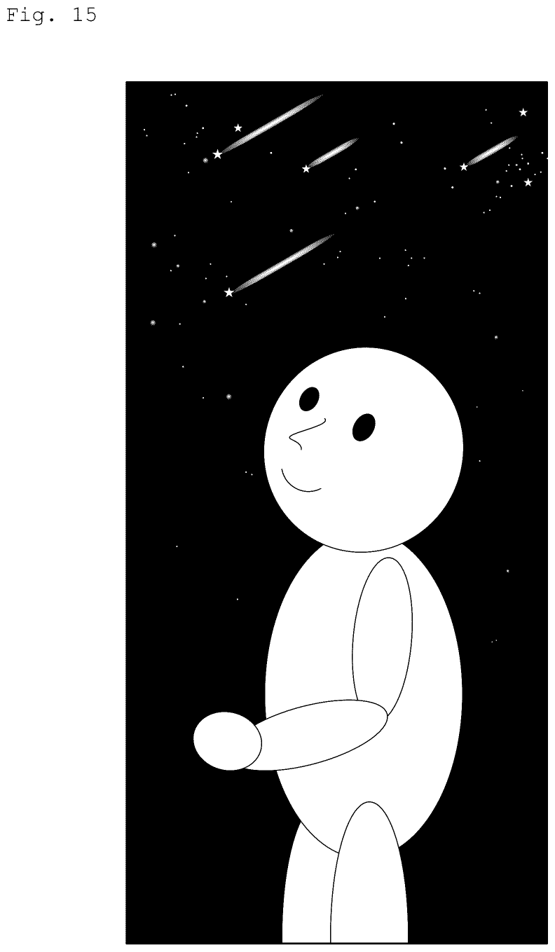

The effect execution process involves setting the background image and the character's motion in accordance with the combination of the character and destination selected by the player, and executing an animation effect in which the background image and the image of the character moving are displayed in combination with each other. FIG. 15 illustrates an example of an animation effect that is executed in the walk event and in which the character looks up under a starry sky. In this embodiment, the walk-event-data storage unit 74 has stored therein effect pattern data in which a combination of the background image according to the destination and the character's motion is set for each character. The effect execution process involves executing the animation effect by referring to the effect pattern data in accordance with the execution details of the walk event confirmed in the execution confirmation process.

In this embodiment, for example, when a task kill is performed before the animation effect is completed in the effect execution process, interruption data containing the player's selection details required for executing the animation effect is stored in the walk-event-data storage unit 74 during an application termination process. If there is interruption data of the walk event (Y in step S105), a resume confirmation dialog is displayed to confirm the intent of whether or not to resume the interrupted walk event. When a confirmation input for resuming the walk event is performed (Y in step S115), the animation effect is executed based on the stored interruption data (step S113). When an input for cancelling the resuming of the walk event is performed while the resume confirmation dialog is being displayed (N in step S115), the resume confirmation dialog is closed and the home screen is recovered.

When the animation effect is completely executed in accordance with the effect execution process, an event termination process is executed (step S114). The event termination process involves releasing content. In detail, if a released flag is not set with respect to the animation effect executed in accordance with the effect execution process by referring to the content-release-status data stored in the walk-event-data storage unit 74, a released flag with respect to the executed animation effect is set in association with the event-targeted character so that new content is released, and the released animation effect can be viewed in a trainer note that enables viewing of various types of information associated with the character.

The event termination process involves performing a process related to acquisition of, for example, a reward. In detail, a walk reward selected by the player when executing the walk event is added to the item list in the player-data storage unit 71, and the affinity parameter associated with the released character corresponding to the event-targeted character is updated. If the affinity rank changes as a result of updating the affinity parameter and there is a story to be released as a result of achieving the affinity rank, the released flag of the story is set in association with the released character corresponding to the event-targeted character, whereby new content is released. The released story can be viewed in a story mode serving as a different game feature.

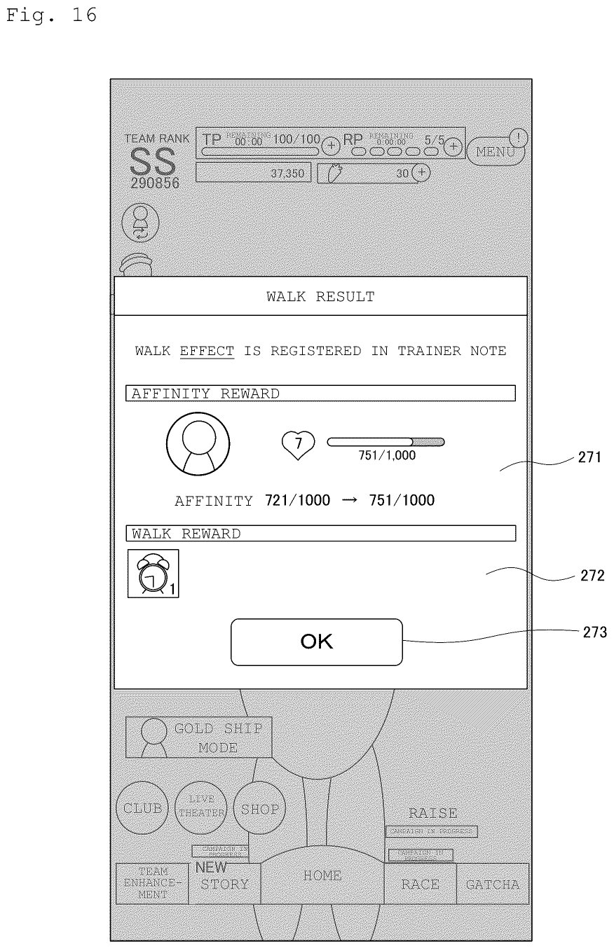

The event termination process involves displaying the execution result of the walk event. For example, as shown in FIG. 16, the player is provided with a notification by displaying a walk result dialog. The walk result dialog is provided with an affinity reward display field 271 and a walk reward display field 272. The affinity reward display field 271 displays the update details of the affinity parameter associated with the event-targeted character in accordance with the execution of the current walk event. The walk reward display field 272 uses, for example, an icon to display the details of the walk reward selected by the player in the current walk event. When a tap input is performed on a confirm button 273 provided on the walk result dialog, the walk result dialog is closed and the home screen is recovered, and the series of processes ends.

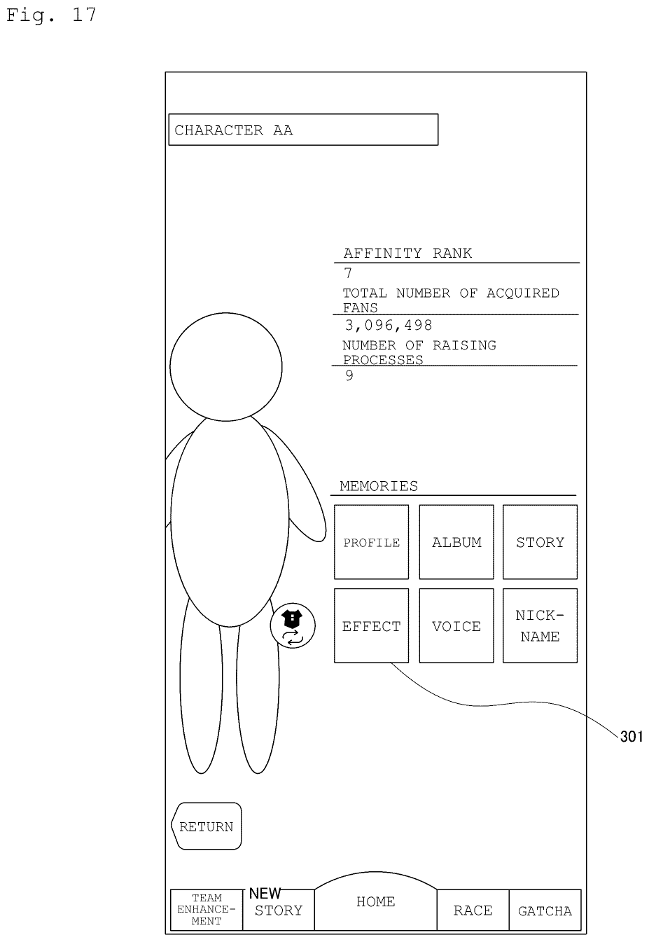

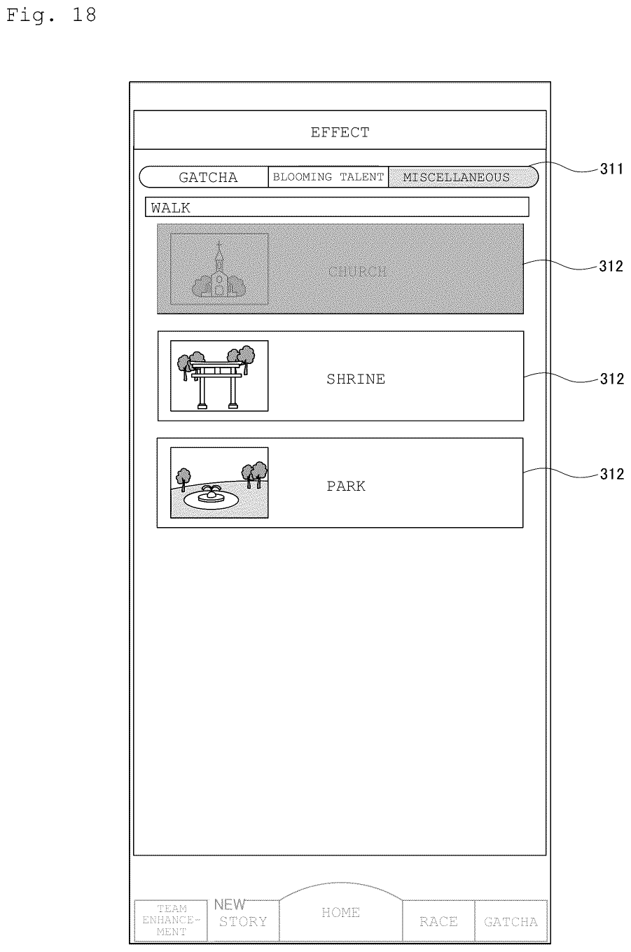

Next, the viewing of the animation effect to be released in the walk event will be described. FIG. 17 illustrates an example of a display screen related to the trainer note mentioned above. In the trainer note, various types of information associated with a character to be viewed are viewable. When a tap input is performed on an effect button 301 while the trainer note of the character to be viewed is displayed, an effect dialog is displayed, as shown in FIG. 18. On the effect dialog, the display targets can be switched by tapping on any of areas corresponding to “gatcha”, “blooming talent”, and “miscellaneous” items by using an tab 311. Animation effects to be released in the walk event are classified into the “miscellaneous” item. By tapping on the area corresponding to “miscellaneous” in the tab 311, a list of animation effects associated with the character to be viewed is displayed. The effect dialog is provided with effect buttons 312 corresponding to the respective animation effects. An effect button 312 for a released animation effect is constantly displayed, whereas an effect button 312 for an unreleased animation effect is grayed out. When viewing of a released animation effect is desired, the animation effect is executed by tapping on the effect button 312 corresponding to the animation effect. When a tap input is performed on the effect button 312 corresponding to an unreleased animation effect, a message indicating that it needs to be released in the walk event is displayed.

In the information processing system 10 according to this embodiment described above, a player is caused to select an event-targeted character, and an animation effect associated with the event-targeted character is released and made freely viewable based on a result obtained by executing an animation effect related to a walk event in association with the event-targeted character. Moreover, in the information processing system 10 according to this embodiment, an affinity parameter associated with the event-targeted character is also updated based on a result obtained by executing the walk event, and a story associated with the event-targeted character is released and made freely viewable if the affinity parameter satisfies a condition related to an increase of affinity rank. In the information processing system 10 according to this embodiment, a walk parameter accumulated in accordance with the usage status of a game, such as a log-in based on activation of an application or use of a raising feature or a competition feature, needs to be consumed as compensation. Therefore, in the information processing system 10 according to this embodiment, the player can be motivated to use the game to accumulate the walk parameter for executing the walk event. In the information processing system 10 according to this embodiment, the player experiences content, such as an animation effect or a story released by executing the walk event. This serves as a trigger for strengthening a new emotional attachment to a character less frequently used up to this point, so that an effect where the less-frequently-used character is used in the game can be expected thereafter. Accordingly, the information processing system 10 according to this embodiment can proactively motivate the player to play the game by using various characters.

In particular, in the information processing system 10 according to this embodiment, since the raising feature and the competition feature has a relationship in which the competition feature is used as means for checking the raising result of a character raised in the raising feature, there is a tendency for bias to occur in the character to be selected and used by the player. In this embodiment, instead of compelling the use of the less-frequently-used character in the raising feature or the competition feature to correct the bias in the usage frequency between characters, the less-frequently-used character is selected as an event-targeted character in the walk event while a favored character of the player is used in the raising feature or the competition feature to accumulate the walk parameter, so that the affinity parameter can also be readily accumulated with respect to the less-frequently-used character, whereby content can also be released with respect to the less-frequently-used character. By viewing the newly-released content, the emotional attachment to the character less frequently used up to this point can be strengthened, so that a motivation for using various characters can be obtained.

In the information processing system 10 according to this embodiment, the walk parameter is resettable at a periodically-occurring reset timing, and the walk parameter is updated to a maximum value during a first log-in to the game in log-in management cycles. Therefore, the walk event can be executed by simply activating and logging into the application once a day, so that the player can be continuously motivated to play the game.

In this embodiment, walk events with multiple different types of destinations are executable for each character. When a walk event is to be executed, selection of a destination for the walk event as an execution target is received after an event-targeted character is selected, and an animation effect according to the combination of the character and destination selected by the player is executed. Thus, different animation effects can be enjoyed even if the same character is selected as the event target for the previous event and the current event, thereby capturing the player's interest and serving as a trigger for strengthening the emotional attachment to the character selected as the event target.

In this embodiment, the event completion status of each character is visually recognizable based on the display modes of the destination icons 216 on the character selection dialog serving as an input interface for receiving selection of an event-targeted character, thereby achieving user-friendliness in the selection of an event-targeted character. By performing a long-press input on any of the character icons 215 on the character selection dialog, a dialog that enables viewing of the released status of the animation effect associated with the character corresponding to the character icon 215 may be displayed. Specifically, a dialog indicating the details of the event completion status of each character on the input interface that receives selection related to an event-targeted character may be invoked based on a predetermined input.

This embodiment has been described with reference to an example of a game involving raising a character in the motif of a racehorse to accumulate a parameter indicating the degree of usage of the character and to thus achieve releasing of content. Alternatively, the features of the information processing system 10 may be offered in another game. An example of the applicable game includes a sports game, such as a baseball game or a soccer game, involving raising a character that is to participate in a competition to accumulate the parameter indicating the degree of usage of the character as a result of raising the character and to thus release content. Another example of the applicable game includes a game in another genre, such as an idol raising game, a card battle game, a fighting game, an action game, a battle royale game, or a role-playing game, involving using a game medium, such as a character, to accumulate the parameter indicating the degree of usage of the used game medium and to thus release content.

1. A program causing a computer to function as:
a first parameter updater that updates a first parameter accumulated in accordance with a usage status of a game;
an execution condition determiner that determines whether or not the first parameter satisfies a condition for executing an event;
a selection receiver that receives selection of an event-targeted game medium when the event is executable;
an event executer that executes the event in association with the event-targeted game medium on a condition that the first parameter is consumed; and
a second parameter updater that updates a second parameter associated with the event-targeted game medium based on a result obtained from executing the event.

2. The program according to claim 1, further causing the computer to function as:
a content releaser that releases content associated with the event-targeted game medium based on the result obtained from executing the event.

3. The program according to claim 1,
wherein the first parameter updater updates the first parameter in association with a log-in to the game.

4. The program according to claim 1,
wherein the first parameter updater allows the first parameter to be resettable at a periodically-occurring reset timing.

5. The program according to claim 1,
wherein a plurality of types of events are executable for each game medium,
wherein the selection receiver receives selection of an event as an execution target after the event-targeted game medium is selected, and
wherein the event executer executes the event selected as the execution target.

6. The program according to claim 5,
wherein the selection receiver allows an event completion status of each game medium to be visually recognizable on an input interface that receives the selection related to the event-targeted game medium.

7. An information processing system comprising:
a first parameter updater that updates a first parameter accumulated in accordance with a usage status of a game;
an execution condition determiner that determines whether or not the first parameter satisfies a condition for executing an event;
a selection receiver that receives selection of an event-targeted game medium when the event is executable;
an event executer that executes the event in association with the event-targeted game medium on a condition that the first parameter is consumed; and
a second parameter updater that updates a second parameter associated with the event-targeted game medium based on a result obtained from executing the event.

8. An information processing method comprising:
a first parameter updating step for updating a first parameter accumulated in accordance with a usage status of a game;
an execution condition determining step for determining whether or not the first parameter satisfies a condition for executing an event;
a selection receiving step for receiving selection of an event-targeted game medium when the event is executable;
an event executing step for executing the event in association with the event-targeted game medium on a condition that the first parameter is consumed; and
a second parameter updating step for updating a second parameter associated with the event-targeted game medium based on a result obtained from executing the event.
